(19) United States
(12) Patent Application Publication
(10) Pub. No.: US 2022/0306045 A1
(43) Pub. Date: Sep. 29, 2022

(54) Windshield and Wiper Blade Deicing System

(71) Applicant: Efraim Weiss, New City, NY (US)

(72) Inventor: Efraim Weiss, New City, NY (US)

(21) Appl. No.: 17/686,548

(22) Filed: Mar. 4, 2022

Related U.S. Application Data
(60) Provisional application No. 63/164,783, filed on Mar. 23, 2021.

(51) Int. Cl. B60S 1/04; B60K 37/06

(52) U.S. Cl. CPC B60S 1/048; B60K 37/06; B60K 2370/12

(57) ABSTRACT

The present invention relates to a windshield and wiper blade deicing system. The system is designed to use a plurality of vents that are angled to blow out or direct warm air from the vehicle engine and heater of the vehicle towards the windshield and wiper blades for quickly melting ice and snow thereon. The plurality of vents can be disposed near, or proximal to, the base of the windshield and the vehicle hood. The system uses internal warm air generated from the vehicle engine, and the heater of the vehicle and control same with a deicing controller. The system can be controlled by a plurality of control buttons disposed on a dashboard of the vehicle. The system can also be controlled remotely by a key fob of the vehicle.

### CROSS-REFERENCE TO RELATED APPLICATION

The present application claims priority to, and the benefit of, U.S. Provisional Application No. 63/164,783, which was filed on Mar. 23, 2021 and is incorporated herein by reference in its entirety.

### FIELD OF THE INVENTION

The present invention relates generally to windshield defrosters. More specifically, the present invention relates to a windshield and wiper blade de-icing system that can be used to quickly melt the ice and snow accumulated on the windshield and wiper blades of a vehicle. The system features a plurality of vents near the base of the windshield and the vehicle hood that are angled to distribute air onto the wiper blades and across the windshield. The system uses internal warm air from engine and heater of the vehicle controlled by a de-icing controller or de-icing mechanism, and the system can be controlled by a plurality of control buttons disposed on dashboard of the vehicle. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

The challenges of getting a vehicle underway each morning or at night in a cold climate are well-known. Such problems are exacerbated when the vehicle is left outside and uncovered. In such scenarios, snow and ice get packed onto the windshield and also on the windshield wiper blades of the vehicle. Especially due to the sloping curvature of the windshield, the ice can be packed at the bottom of the windshield, wherein the wiper blades can become completely frozen or blocked by the ice and snow. Snow accumulation on windshields and windshield wiper blades endangers the driver and other passengers. Accumulated snow causes navigational difficulties and unsafe driving conditions. Snow on windshields and windshield wipers decreases driver visibility and safety.

By way of background, defrosters and deicers are used in vehicles to melt and scrape the ice off of the windshield manually or automatically when the vehicle is started. A user has to wait for the built-in defroster to warm up and function on full blast to remove ice from the windshield. Further, when the ice is hard and has many layers, conventional defrosters take a lot of time. This is uncomfortable, frustrating and time-consuming for many users.

When a vehicle is in operation, a defroster may work to defrost the ice from the windshield. However, when the car is parked and the engine is off, the defroster is not operational and a driver must start the car well before the desired time of departure in order to heat the windshield enough to enable the ice, frost and/or snow to be melted and removed before driving. Even during operation of the vehicle, the wiper blades can remain laden with snow.

As stated, conventional defrosters do not scrape or melt the snow packed on the windshield wiper blades, as the wipers are generally positioned at the bottom of the windshield when the vehicle is off and parked. The packed snow on the wipers does not allow the wipers to work effectively, and a user such as a driver of a vehicle, has to manually scrape and remove the snow. Manual removal of snow from the wipers is a daunting and laborious task. When snowfall and snow accumulation is ongoing, conventional defrosters may be inadequate to remove snow from the windshield, and accumulated snow on the wipers may not be removed or melted effectively.

Conventional defrosters are not effective to remove and melt heavy snow as the orientation of the vents and the heating wires on the windshield take time and are directed towards only the windshield. In some cases, temperature control and speed of defrosting may not be available to a user. A user has to sit in the car for few minutes, or warm the vehicle ahead of time, before embarking on the journey, and even in such cases, the user still has to manually clear the snow and ice from the wiper blades.

Therefore, there exists a long felt need in the art for a deicing system that defrosts the accumulated ice on both the windshield and the windshield wiper blades in an operational (driving) and non-operational (non-driving) vehicle status. There is also a long felt need in the art for a deicing system that quickly defrosts the ice on both the windshield and the windshield wiper blades thus eliminating the wait time of a user for defrosting the same prior to operating the vehicle. Additionally, there is a long felt need in the art for a deicing system that can be integrated to the vehicle. Further, there is a long felt need in the art for a deicing system that does not need any additional source of power for melting ice and snow. Moreover, there is a long felt need in the art for a deicing system that eliminates the manual clearing away of snow and ice by hand (i.e. with a handheld ice scraper). Finally, there is a long felt need in the art for a deicing system with heat distribution and temperature that can be controlled from controls present within the vehicle.

The subject matter disclosed and claimed herein, in one potential embodiment thereof, comprises a windshield and wiper blade deicing system. The windshield and wiper blades deicing system can be integrated to the vehicle and quickly melts ice and snow accumulated on the windshield and wiper blades. The windshield and wiper blades deicing system has a deicing controller or mechanism, a plurality of deicing vents and a plurality of control buttons disposed on the dashboard. The deicing controller or deicing mechanism controls the flow of internal warm air from the engine and heater of the vehicle to the plurality of deicing vents. The plurality of vents can be disposed at the bottom of the windshield, and the direction of the vents can be directed towards the windshield and the wiper blades. The system further includes a built-in control button for activating and deactivating the deicing system, a speed control button for adjusting the speed of warm air flow from the vents, and a temperature control button for adjusting the temperature of warm air blowing from the vents disposed on the dashboard. The warm air blowing out from the vents quickly melts the ice and snow accumulated on the windshield and wiper blades.

In this manner, the windshield and wiper blade deicing system of the present invention accomplishes all of the forgoing objectives and provides a relatively easy, effective, quick and convenient system and method for melting snow and ice frozen on the wiper blades and windshield. The system eliminates the need of a user to wait for the defroster system of the vehicle to melt the snow and ice. The system uses specially designed vents, enabling the warm air of the vehicle to be directed to both the windshield and the wiper blades, enabling rapid melting of ice, thereby providing safety and convenience to the users.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one potential embodiment thereof, comprises a windshield and wiper blade deicing system. The windshield and wiper blade deicing system can be integrated to the vehicle, and quickly melts ice and snow accumulated on the windshield and wiper blades. The windshield and wiper blade deicing system has a deicing controller, a plurality of deicing vents and a plurality of control buttons disposed on the dashboard. The deicing controller or mechanism controls the flow of internal warm air from the engine and heater of the vehicle to the plurality of deicing vents. The plurality of vents can be disposed at the bottom of the windshield, and the direction of the vents can be directed towards the windshield and the wiper blades. The system further includes a built-in control button for activating and deactivating the deicing system, a speed control button for adjusting speed of warm air flow from the vents, and a temperature control button for adjusting temperature of warm air blowing from the vents disposed on the dashboard. The warm air blowing out from the vents quickly melts the ice and snow accumulated on the windshield and wiper blades.

In yet another embodiment of the present invention, the deicing controller is connected to a main electronic control unit (ECU) of the vehicle for integration into the vehicle during manufacturing.

In yet another embodiment of the present invention, a method of deicing a vehicle windshield and wiper blades is described. The method includes: providing a plurality of deicing vents at the bottom of the windshield; controlling by a controller flow the of warm air to the plurality of deicing vents, wherein the warm air is transmitted from an internal engine and heater of the vehicle; and, blowing warm air from the vents towards the windshield and the wiper blades for melting accumulated ice.

In yet another embodiment, the method further includes: controlling activation and deactivation of the deicing using a control button disposed on a dashboard of the vehicle; and, adjusting temperature and speed of the warm air blown out from the vents using control buttons disposed on the dashboard of the vehicle.

In yet another embodiment of the present invention, a windshield and windshield wiper ice melting system is disclosed. The system includes: a controller connected to the main ECU; a plurality of vents wherein the plurality of vents blows out warm air from the engine area; and, control buttons disposed on the dashboard for controlling the temperature and speed of the warm air blowing out of the vents.

In a further embodiment of the present invention, the deicing system can be remotely controlled using a key fob of the vehicle, enabling a scheduled or preparatory deicing of the windshield and wiper blades prior to vehicle operation.

Advantageously, the deicing system and method of the present invention allow quick and effective melting of snow and ice frozen to the wipers and windshield glass, thereby saving extensive time and effort when operating a vehicle during the winter months. The invention eliminates the need to wait for a defroster system to warm up, and prevents an operator from having to manually clear away snow and ice by hand.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of windshield and wiper blades deicing system of the present invention in accordance with the disclosed architecture;

FIG. 2 illustrates a perspective view of a vehicle showing deicing vents positioned at the bottom of the windshield for deicing in accordance with the disclosed architecture;

FIG. 3 illustrates a perspective view of dashboard of the vehicle having integrated control buttons for controlling the operation of the deicing system of the present invention in accordance with the disclosed architecture;

FIG. 4A illustrates a perspective view showing accumulation of snow packed on windshield wiper blades of the vehicle;

FIG. 4B illustrates a perspective view showing the lack of snow after melting same by warm air from the deicing vents in accordance with the disclosed architecture; and

FIG. 5 illustrates a user operating a key fob of the vehicle for remotely initiating the windshield and windshield wiper deicing system of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a deicing system that defrosts the accumulated ice on both the windshield and the windshield wiper blades, in an operational (driving) and non-operational (non-driving) vehicle status. There is also a long felt need in the art for a deicing system that quickly defrosts the ice on both the windshield and the windshield wiper blades, thus eliminating wait of a user for defrosting same prior to operating the vehicle. Additionally, there is a long felt need in the art for a deicing system that can be integrated to the vehicle. Further, there is a long felt need in the art for a deicing system that does not need any additional source of power for melting ice and snow. Moreover, there is a long felt need in the art for a deicing system that eliminates manual clearing away of snow and ice by hand (i.e. with a handheld ice scraper). Finally, there is a long felt need in the art for a deicing system with heat distribution and temperature that can be controlled from controls present within the vehicle.

The present invention, in one potential embodiment, a method of deicing vehicle windshield and wiper blades is described. The method includes: providing a plurality of deicing vents at the bottom of the windshield; controlling by a controller flow of warm air to the plurality of deicing vents, wherein the warm air is transmitted from an internal engine and heater of the vehicle; and, blowing warm air from the vents towards the windshield and the wiper blades for melting accumulated ice.

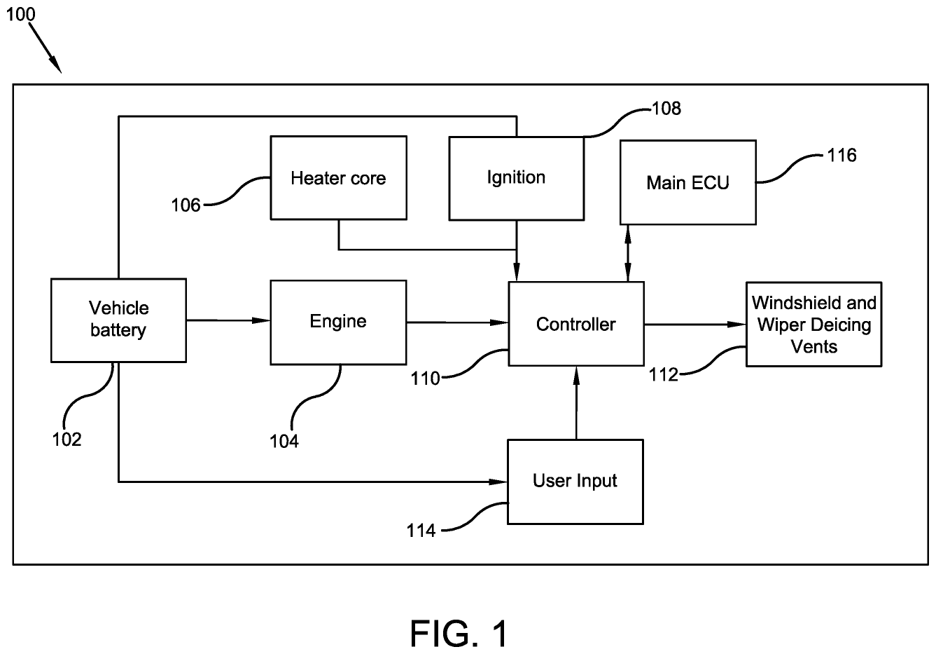

Referring initially to the drawings, FIG. 1 illustrates a perspective view of one potential embodiment of a windshield and wiper blade deicing system of the present invention in accordance with the disclosed architecture. The windshield and wiper blades deicing system 100 is designed to clear away snow and ice accumulation on wiper blades and windshields. The system 100 is integrated into a vehicle, and uses warm air from the internal (i.e. combustion) engine 104 of a vehicle for melting snow and ice packed on the windshield and wiper blades of the vehicle. The system 100 includes a plurality of vents 112 disposed on, or proximal to, the bottom of the windshield that directs warm air from the engine 104 onto the windshield wiper blades and windshield glass to melt snow and ice. More specifically, the deicing system 100 uses the existing heating elements and internal heat from the engine of the vehicle and a controller 110 to control the operation of venting warm air from the vents 112. The controller 110 receives input from a heater core 106 that is positioned just behind the dashboard of the vehicle, along with input from the engine 104. The warm air from the engine 104 and the heater core 106 are transmitted under the control of the controller 110 through an internal air pipe to the vents 112.

The system 100 can be easily controlled by a user from a plurality of controls disposed on the dashboard of the vehicle. A plurality of user inputs 114, such as activation of the system 100 or adjusting the speed of warm air from the vents 112, can be transmitted to the controller 110, thereby enabling the controller 110 to control the operation of the system 100. The controller 110 also receives information on the status of the ignition 108 of the vehicle, thus disabling the system 100 when the ignition 108 of the vehicle is off.

The vehicle battery 102 can be used for powering the engine 104, for operating and transmitting the user input 114 and for actuating the ignition 108 of the vehicle. It should be appreciated that the system 100 can be integrated into the vehicle electronic system. To increase the utility of the deicing windshield and wiper blades of the vehicle, any other existing component of the vehicle can also be used. The controller 110, in its simplest form, can be an on-off switch that closes the connection of the deicing vents 112. In addition, the deicing controller or deicing mechanism 110 can be connected to the main ECU 116, and its state/status can be set to either the ON state or the OFF state by an instruction signal from the main ECU 116.

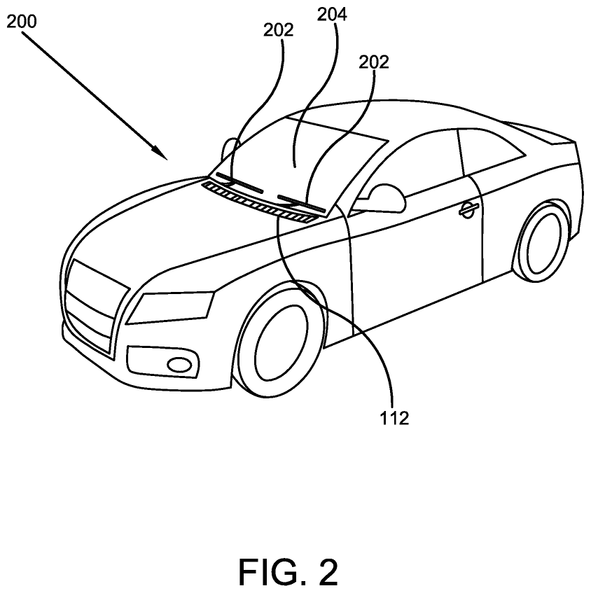

FIG. 2 illustrates a perspective view of a vehicle showing deicing vents positioned at the bottom of the windshield for deicing in accordance with the disclosed architecture. The deicing vents 112 are used for venting out warm air from the internal engine and heater of the vehicle 200. The vents 112 are disposed at the bottom of the windshield 204, and the direction of the warm air is directed towards the wiper blades 202 and the windshield 204, such that the ice and snow caked or packed on the wiper blades 202 and the windshield 204 can be melted quickly, wherein a user will not have to wait for the defroster to work on full blast. The advantage of the positioning of the vents 112 is that they do not obstruct viewing of the windshield 204.

The vents 112 receive warm air from the internal (i.e. combustion) engine and heater of the vehicle 200, and blow the same onto the windshield wipers 202 and windshield glass 204 to melt snow and ice. In a parked condition, the conventional defroster takes a lot of time to defrost the ice. The warm air from the vents 112 accelerates defrosting and can melt the ice quickly, thereby preventing a user from having to wait unduly prior to operating the vehicle. Further, the vents 112 are directed at the wiper blades 202 in a resting or non-operating position, thereby enabling ice and snow packed on the wiper blades 202 to melt quickly. This is beneficial as the conventional defrosters, working from the inside of the windshield, are ineffective in melting snow accumulated on the wiper blades 202, even after an extended period of time.

The vehicle 200 can be a vehicle including an internal combustion engine and an electric motor as the driving source of the vehicle (so-called hybrid vehicle), or may be a vehicle having only an electric motor but not having an internal combustion engine as the driving source of the vehicle (so-called electric vehicle).

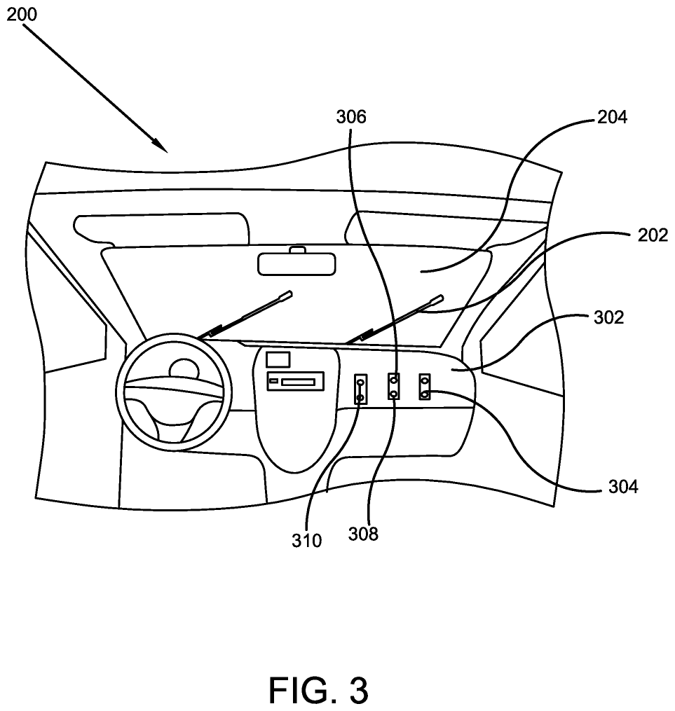

FIG. 3 illustrates a perspective view of the dashboard of the vehicle having integrated control buttons for controlling the operation of the deicing system of the present invention in accordance with the disclosed architecture. The deicing system and the mechanism of venting out warm air from the engine of the vehicle 200 through the deicing vents are integrated into the vehicle 200. The dashboard 302 of the vehicle 200 can include a built-in control button 304 to activate or deactivate the deicing system 100. When activated using the control button 304, the deicing system 100 blows out warm air from the vents 112 (as shown in FIG. 2) towards the wipers 202 and the windshield 204 to quickly melt ice and snow.

Temperature or source control buttons 306, 308 allow a user to increase and decrease the temperature and/or change the sources of warm air blowing out of the deicing vents respectively. When the temperature control button 306 is activated, warm air from both the engine and the heater of the vehicle 200 is mixed and blows out from the respective deicing vents on both the outside (i.e. exterior) and inside (i.e. interior) of the vehicle 200 across the windshield. When the temperature control button 308 is pressed, warm air only from the engine of the vehicle 200 can be selectively blown out across the outside or exterior of the windshield 204. This is especially useful, thereby enabling the user to quickly melt the hard ice and snow without any wait.

The speed control buttons 310 allow the speed of the warm air blowing out from the deicing vents to be selectively increased or decreased, as per the preferences of a user. It should be appreciated that the deicing system of the present invention can work independently of the conventional defrosting system of the vehicle 100, or can also work in conjunction with the defrosting system.

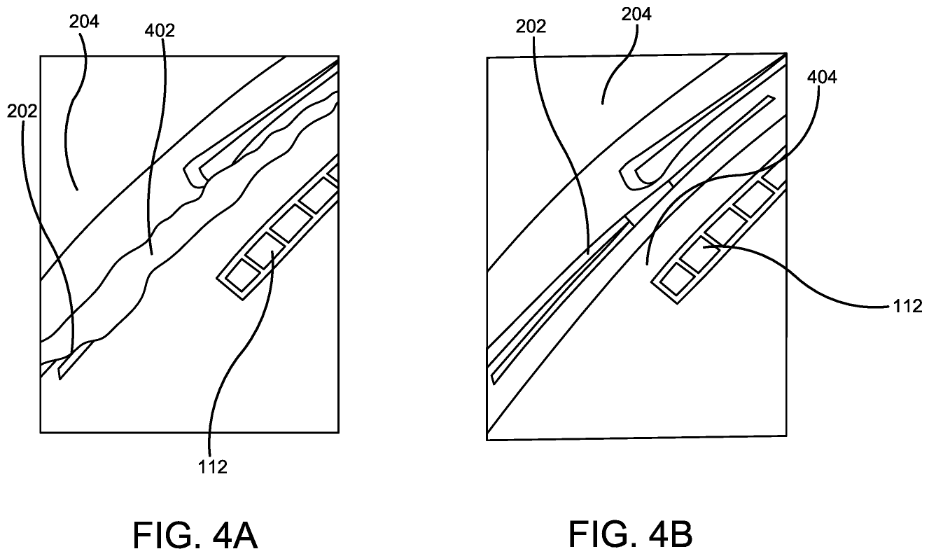

FIGS. 4A and 4B illustrate perspective views showing how snow packed on the windshield wiper blades of a vehicle is melted by warm air from the deicing vents in accordance with the disclosed architecture. As shown in FIG. 4A, ice 402 is packed onto the wiper blade 202 which inhibits the wiper blade 202 from working effectively. Further, the conventional defroster of the vehicle is not able to efficiently melt the ice 402 packed on the blade 202. The deicing vents 112 are positioned below the windshield 202, and are aimed or directed towards the wiper blade 202 and the windshield 204.

In FIG. 4B, warm air 404 is directed from the deicing vents 112 towards the wiper blade 202 and the windshield 204 for melting ice accumulated on the wiper blade 202 quickly and efficiently. In an alternate version of the invention, the power source for providing warm air to the deicing system can be a dedicated power source, rather than being the car battery. The dedicated power source can be, for example, a 15-Volt battery or a plurality of batteries as would be appropriate to produce the desired level of warm air.

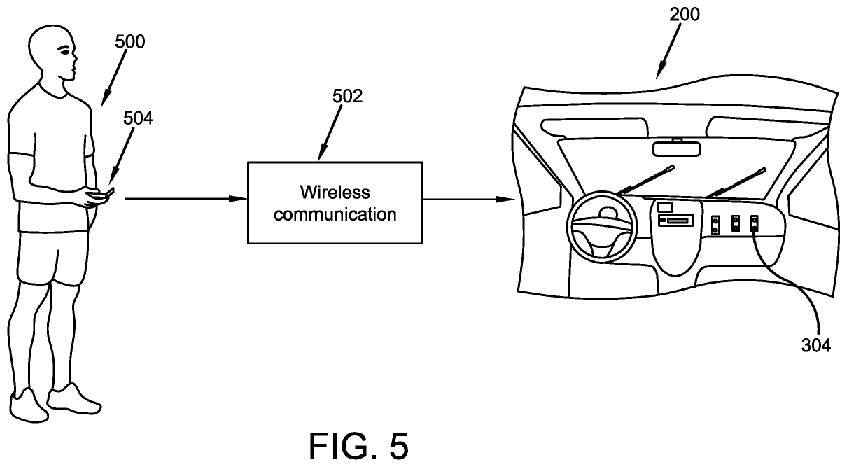

FIG. 5 illustrates a user operating the key fob of the vehicle for remotely initiating windshield and windshield wipers deicing system of the present invention in accordance with the disclosed architecture. For the vehicle 200 that comes equipped with a wireless key fob 504 for remotely operating and controlling the vehicle 200, the key fob 504 can connect to the vehicle 200 through the wireless communication channel 502 for initiating and controlling the integrated vehicle deicing system 100 by activating the control button 304. The key fob 504 is helpful for scenarios where the user 500 is approaching the vehicle 500 for use in heavy snowfall.

Consequently, by incorporating the windshield and wiper blade deicing system 100 in the vehicle 200, the present invention greatly facilitates quick and effective melting of the ice and snow accumulated on the windshield and wiper blades, using internal warm air of the engine and heater of the vehicle 200. The system 100 eliminates the need to wait for a defroster system to warm up, and prevents having to manually clear away snow and ice by hand or with any other handheld tool. When the vehicle is parked or non-operating, the system 100 quickly melts the ice by directing the warm air towards the windshield and the wiper blades.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “windshield and wiper blade deicing system”, “windshield deicing”, “deicing system”, “vehicle deicing system”, and “system” are interchangeable and refer to the windshield and wiper blade deicing system 100 of the present invention.

Notwithstanding the forgoing, the windshield and wiper blades deicing system 100 of the present invention can be of any suitable size and configuration as is known in the art without affecting the overall concept of the invention, provided that it accomplishes the above-stated objectives. One of ordinary skill in the art will appreciate that the size, configuration, and material of the windshield and wiper blade deicing system 100 as shown in the FIGS. are for illustrative purposes only, and that many other configurations of the windshield and wiper blade deicing system 100 are well within the scope of the present disclosure. Although the relative dimensions of the windshield and wiper blade deicing system 100, as shown in the FIGS., are important design parameters for user convenience, the windshield and wiper blade deicing system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A windshield and wiper blades deicing system comprising:
a deicing mechanism;
a plurality of deicing vents;
a plurality of control buttons disposed on a vehicle dashboard, wherein said deicing mechanism controls flow of warm air from a vehicle engine to said plurality of deicing vents; and
wherein said plurality of deicing vents disposed on the outside of said vehicle proximal to a bottom area of a windshield, and further wherein said plurality of deicing vents directed towards said bottom areas of the windshield and the wiper blades.

2. The windshield and wiper blades deicing system of claim 1, wherein said plurality of control buttons selectively activate said deicing mechanism.

3. The windshield and wiper blades deicing system of claim 1, wherein said plurality of control buttons further comprise a speed control button for adjusting speed of warm air flow from said plurality of deicing vents.

4. The windshield and wiper blades deicing system of claim 1, wherein said plurality of control buttons further comprise a temperature control button for adjusting temperature of warm air blowing from said plurality of deicing vents.

5. The windshield and wiper blades deicing system of claim 1, wherein said deicing mechanism controls flow of internal warm air from the engine of said vehicle to said plurality of deicing vents.

6. The windshield and wiper blades deicing system of claim 2, wherein said plurality of control buttons are remote control buttons.

7. A windshield and wiper blades deicing system comprising:
a deicing mechanism;
a plurality of deicing vents;
a plurality of control buttons disposed on a vehicle dashboard, wherein said deicing mechanism controls flow of internal warm air from a vehicle engine and a heater of the vehicle to said plurality of deicing vents; and
wherein said plurality of deicing vents disposed on the outside of said vehicle proximal to a bottom area of a windshield, and further wherein said plurality of deicing vents directed towards said bottom areas of the windshield and the wiper blades.

8. The windshield and wiper blades deicing system of claim 7, wherein said plurality of control buttons selectively activate said deicing mechanism.

9. The windshield and wiper blades deicing system of claim 7, wherein said plurality of control buttons further comprise a speed control button for adjusting speed of warm air flow from said plurality of deicing vents.

10. The windshield and wiper blades deicing system of claim 7, wherein said plurality of control buttons further comprise a temperature control button for adjusting temperature of warm air blowing from said plurality of deicing vents.

11. The windshield and wiper blades deicing system of claim 8, wherein said plurality of control buttons are remote control buttons.

12. A method of deicing a vehicle windshield and wiper blades, the method comprising the steps of:
providing a plurality of deicing vents proximal to a bottom area of said vehicle windshield;
controlling by a controller a flow of warm air to said plurality of deicing vents wherein the warm air is transmitted from an internal engine of a vehicle;
directing said flow of warm air from said plurality of deicing vents towards said vehicle windshield and said wiper blades for melting accumulated ice thereon, wherein said directing said flow of warm air is towards an exterior of said vehicle windshield; and
controlling activation and deactivation of said flow of warm air using a control button disposed on a dashboard of said vehicle.

13. The method of claim 12, wherein said control button connected to a vehicle ECU.

14. The method of claim 13, wherein said plurality of deicing vents direct warm air from an area adjacent to said internal engine across said vehicle windshield and said wiper blades.

15. The method of claim 14 further comprising a step of remotely controlling said activation and deactivation of said flow of warm air using a key fob of said vehicle.

16. The method of claim 15 further comprising a step of activating said flow of warm air prior to operating said vehicle.

17. The method of claim 12 further comprising a step of adjusting a temperature of said flow of warm air from said plurality of deicing vents using said control button.

18. The method of claim 12 further comprising a step of adjusting a speed of said flow of warm air from said plurality of deicing vents using said control button.

19. The method of claim 15 further comprising a step of adjusting a temperature of said flow of warm air from said plurality of deicing vents using said control button.

20. The method of claim 15 further comprising adjusting a speed of said flow of warm air from said plurality of deicing vents using said control button.
